(19) United States
(12) Patent Application Publication
(10) Pub. No.: US 2012/0105610 A1
(43) Pub. Date: May 3, 2012

(54) METHOD AND APPARATUS FOR PROVIDING 3D EFFECT IN VIDEO DEVICE

(75) Inventors: Sang-Jun Ahn, Seoul (KR); Je-Han Yoon, Seongnam-si (KR)

(73) Assignee: SAMSUNG ELECTRONICS CO., LTD., Suwon-si (KR)

(21) Appl. No.: 13/288,725

(22) Filed: Nov. 3, 2011

(30) Foreign Application Priority Data
Nov. 3, 2010 (KR) 10-2010-0108502

(51) Int. Cl. H04N 13/04

(52) U.S. Cl. 348/54; 348/E13.036

(57) ABSTRACT

An apparatus and method of a video device provide a stereoscopic effect to a user to provide a 3 Dimensional (3D) video. The apparatus includes a 3D glasses recognition unit and a controller. The 3D glasses recognition unit determines a posture of a user who watches a stereoscopic video. The controller provides control to change the stereoscopic effect of the stereoscopic video according to the posture of the user determined by the 3D glasses recognition unit.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Nov. 3, 2010, and assigned Serial No. 10-2010-0108502, the entire disclosure of which is hereby incorporated by reference.

### TECHNICAL FIELD OF THE INVENTION

The present disclosure relates to an apparatus and method for providing an optimal stereoscopic effect to a user in a video device for providing a 3 Dimensional (3D) video. More particularly, the present disclosure relates to an apparatus and method for horizontally aligning 3D glasses worn by a user to a screen for providing a stereoscopic video in a video device.

### BACKGROUND OF THE INVENTION

Research on 3 Dimensional (3D) video implementation mechanisms are actively ongoing in recent video technologies in order to express video information which is more realistic and close to reality. There is a method for providing a 3D stereoscopic feeling by using a human visual feature. In this method, a left-viewpoint image and a right-viewpoint image are scanned onto respective positions and thereafter the two images are separately perceived by the left and right eyes of a viewer. This method is expected to be widely recognized in several aspects. For example, a portable video device equipped with a Barrier Liquid Crystal Display (LCD) (i.e., a stereoscopic mobile phone, a stereoscopic camera, a stereoscopic camcorder, a 3D Television (TV) set, and such) can provide a more realistic video to a user by reproducing stereoscopic contents.

When using a stereo vision technique, the portable video device uses two camera modules to composite two images acquired by using the camera modules, and thus acquires stereo images that enable a user to have a stereoscopic view. In general, a process of compressing the stereo images is performed by using a simulcast scheme and a compatible scheme or by using the compatible scheme and a joint scheme. Thereafter, the portable video device reproduces the compressed data and thus provides a stereoscopic effect to the user.

The user can have an optimal stereoscopic effect when a screen of the video device is viewed horizontally. That is, in order for the user who wears 3D glasses to have the optimal stereoscopic effect, the user needs to sit in a correct posture while viewing a video output from the portable video device.

For this reason, there is a problem in that the user cannot have the stereoscopic effect in a situation where the user watches the video output from the portable video device in a posture in which the user leans on a cushion or sofa.

Therefore, in order to solve the aforementioned problems, there is a need for an apparatus and method for changing a value configured for a stereoscopic effect depending on a user's posture in a video device.

### SUMMARY OF THE INVENTION

To address the above-discussed deficiencies of the prior art, it is an aspect of the present disclosure to provide an apparatus and method for providing an optimal 3 Dimensional (3D) effect in a video device.

Another aspect of the present disclosure is to provide an apparatus and method for changing a location of an output screen depending on a location of 3D glasses in a video device.

Another aspect of the present disclosure is to provide an apparatus and method for changing a sound configuration depending on a location of 3D glasses.

Another aspect of the present disclosure is to provide an apparatus and method for recognizing a user who wears 3D glasses in a video device.

In accordance with an aspect of the present disclosure, an apparatus for providing a stereoscopic effect is provided. The apparatus includes a 3D glasses recognition unit and a controller. The 3D glasses recognition unit determines a posture of a user who watches a stereoscopic video. The controller provides control to change the stereoscopic effect of the stereoscopic video according to the posture of the user determined by the 3D glasses recognition unit.

In accordance with another aspect of the present disclosure, a method of providing a stereoscopic effect is provided. A posture of a user who watches a stereoscopic video is determined by a 3 Dimensional (3D) glasses recognition unit. The stereoscopic effect of the stereoscopic video is changed depending on the determined posture of the user.

In accordance with yet another aspect of the present disclosure, an apparatus is provided. The apparatus includes a three-dimensional (3D) viewing device recognition unit and a controller. The 3D viewing device recognition unit determines a posture of a user who watches a stereoscopic video. The controller adjusts a stereoscopic effect of a display device according to the determined posture of the user.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features and advantages of certain embodiments of the present disclosure will be more apparent from the following detailed description taken in conjunction with the accompanying drawings, in which:

FIG. 1 illustrates a structure of a video device for providing an optimal 3 Dimensional (3D) effect to a user according to an embodiment of the present disclosure;

FIG. 2 illustrates a process of correcting a location of an output screen depending on a posture of a user in a video device according to an embodiment of the present disclosure;

FIG. 3 illustrates a process of regulating a sound volume depending on a location of a user in a video device according to an embodiment of the present disclosure;

FIG. 4A illustrates acquiring sensing information generated from 3D glasses in a video device according to an embodiment of the present disclosure;

FIG. 4B illustrates a screen for acquiring sensing information generated from 3D glasses in a video device according to an embodiment of the present disclosure;

FIG. 5A illustrates a situation capable of providing an optimal stereoscopic effect in a video device according to an embodiment of the present disclosure; and

FIG. 5B illustrates changing a screen configuration depending on a posture of a user in a video device according to an embodiment of the present disclosure.

Throughout the drawings, like reference numerals will be understood to refer to like parts, components and structures.

### DETAILED DESCRIPTION OF THE INVENTION

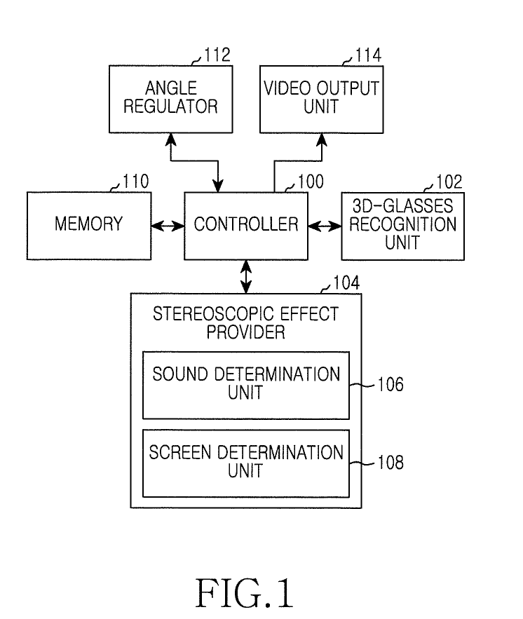

FIGS. 1 through 5B, discussed below, and the various embodiments used to describe the principles of the present disclosure in this patent document are by way of illustration only and should not be construed in any way to limit the scope of the disclosure.

An apparatus and method for providing an optimal 3 Dimensional (3D) effect to a user by differently applying a stereoscopic effect depending on a location of 3D glasses in a video device will be described hereinafter according to embodiments of the present disclosure. The video device is a portable terminal that can output video data. Examples of the video device include a Portable Multimedia Player (PMP), a mobile communication terminal, a smart phone, a laptop, a 3D Television (TV) set, and such.

FIG. 1 illustrates a structure of a video device for providing an optimal 3D effect to a user according to an embodiment of the present disclosure.

Referring to FIG. 1, the video device includes a controller 100, a stereoscopic effect provider 104, a memory 110, an angle regulator 112, a video output unit 114, and a 3D-glasses recognition unit 102. The stereoscopic effect provider 104 includes a sound determination unit 106 and a screen determination unit 108.

The controller 100 of the video device provides overall control to the video device. For example, the controller 100 performs processing and controlling for general video and 3D video outputs. In addition to a typical function, according to the present disclosure, the controller 100 detects 3D glasses upon outputting the 3D video so as to determine a user's posture, and performs processing for regulating a sound and an output direction of the video device such that the user can acquire an optimal 3D effect.

The stereoscopic effect provider 104 provides a 3D effect added with reality by using videos captured in various angles. According to the present disclosure, the stereoscopic effect provider 104 determines whether a currently configured stereoscopic effect is configured to provide an optimal stereoscopic effect.

The sound determination unit 106 of the stereoscopic effect provider 104 uses a distance to the 3D glasses to determine whether a distance to a current user is suitable for feeling an optimal sound.

The screen determination unit 108 of the stereoscopic effect provider 104 uses horizontal information of the 3D glasses to determine whether a posture of the current user is suitable for feeling an optimal video.

The memory 110 preferably includes, for example, a Read Only Memory (ROM), a Random Access Memory (RAM), a flash ROM, and such. The ROM stores a microcode of a program, by which the controller 100 and the stereoscopic effect provider 104 are processed and controlled, and a variety of reference data.

The RAM is a working memory of the controller 100 and stores temporary data that is generated while various programs are performed. The flash ROM stores multimedia data to be played back by using the video device.

The angle regulator 112 regulates up, down, left, and right angles of the video output unit 114 under the control of the controller 100 such that the user can feel the optimal 3D effect. That is, the angle regulator 112 may include a driving motor capable of regulating an angle of the video output unit 114. For example, when information indicating that the user is watching a video while leaning to the left from the center of the video device is received from the controller 100, the angle regulator 112 operates the driving motor to regulate an angle of the video output unit 114 accordingly (e.g. to the left), such that the user can watch the 3D video.

The video output unit 114 displays information such as state information, which is generated while the portable terminal operates, alphanumeric characters, large volumes of moving and still pictures, and such. The video output unit 114 may be a color Liquid Crystal Display (LCD), Active Mode Organic Light Emitting Diode (AMOLED), and such. The video output unit 114 may include a touch input device as an input device when using, a touch input type portable terminal.

The 3D-glasses recognition unit 102 recognizes a location of the 3D glasses worn by the user to watch the 3D video of the video device. The 3D-glasses recognition unit 102 may include a camera capable of acquiring sensing information generated from the 3D glasses. Furthermore, the 3D-glasses recognition unit 102 may be a face recognition module capable of determining a shape of a user's face (i.e., a posture of the user).

In addition, the 3D glasses (not illustrated) are glasses for watching a stereoscopic video. According to the present disclosure, the 3D glasses include a plurality of sensors to generate sensing information that can be recognized by the 3D-glasses recognition unit 102. The 3D glasses generate an Infra-Red (IR) ray by using an IR Light Emitting Diode (LED) according to an embodiment of the present disclosure. Therefore, the IR ray which cannot be recognized by eyes of the user can be recognized by using the 3D-glasses recognition unit 102.

Although a function of the stereoscopic effect provider 104 can be performed by the controller 100 of the video device, these elements are shown to be separately constructed for illustrative purposes only. Thus, those of ordinary skilled in the art can understand that various modifications can be made within the scope of the present disclosure. For example, functions of the two elements can be both processed by the controller 100.

An apparatus for providing an optimal 3D effect to a user by differently applying a stereoscopic effect depending on a location of 3D glasses in a video device has been described above. Hereinafter, a method for providing an optimal 3D effect to a user by using the device will be described according to an embodiment of the present disclosure.

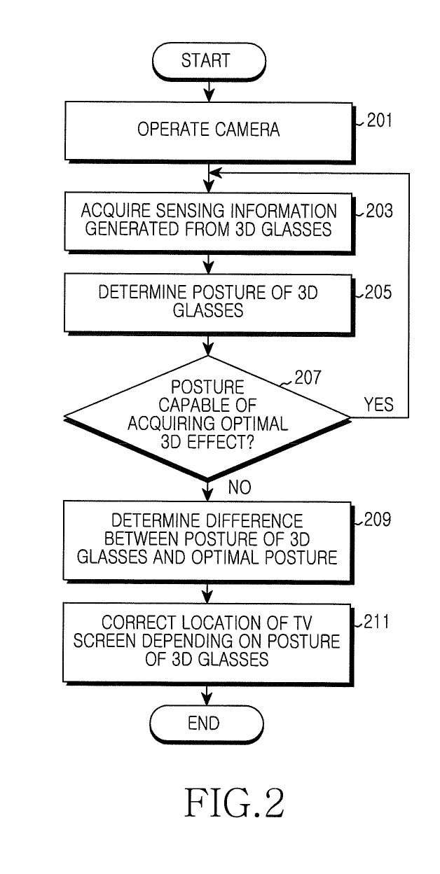

FIG. 2 illustrates a process of correcting a location of an output screen depending on a posture of a user in a video device according to an embodiment of the present disclosure.

Referring to FIG. 2, the video device operates a camera in step 201. The video device includes the camera to recognize the posture of the user who wears 3D glasses.

In step 203, the video device acquires sensing information generated from the 3D glasses. In step 205, the video device determines a posture of the 3D glasses; that is, the posture of the user who wears the 3D glasses. According to an embodiment, the video device can determine the posture of the user by using a face recognition function. However, since a face recognition rate may be decreased as the user wears the 3D glasses, the posture of the user may be determined by using the sensing information generated from the 3D glasses.

In step 207, the video device evaluates a result of step 205.

If it is determined in step 207 that the posture of the user is a posture capable of acquiring the optimal 3D effect, the process of step 203 is repeated. According to an embodiment, the video device may provide an optimal effect when the 3D glasses are horizontally aligned to a 3D screen. Therefore, the user's posture capable of acquiring the optimal 3D effect is a correct posture in which the user who wears the 3D glasses maintains the 3D screen horizontally.

Otherwise, if it is determined in step 207 that the posture of the user is a posture not capable of acquiring the optimal 3D effect, proceeding to step 209, the video device determines a difference between a reference posture capable of acquiring the optimal 3D effect and the posture of the user.

According to an embodiment, the posture of the user may be determined to be a posture not capable of acquiring the optimal 3D effect when the posture corresponds to a posture in which the 3D glasses are not horizontally (or vertically) aligned to the 3D screen, for example, a posture in which the user leans on a specific object while watching, the video or a posture in which the user lies on a sofa while watching the video. The reference posture capable of acquiring the optimal 3D effect is a virtual posture capable of providing sensing information in a state where the 3D glasses are horizontally aligned to the 3D screen.

In step 211, the video device corrects a screen location of the video device according to the posture of the user who wears the 3D glasses. For example, when it is determined that the user is watching the 3D video from the left side, the video device may rotate (e.g. tilt or move about an axis) the orientation of the video device such that the user can watch the video from the front side.

Thereafter, the procedure of FIG. 2 ends.

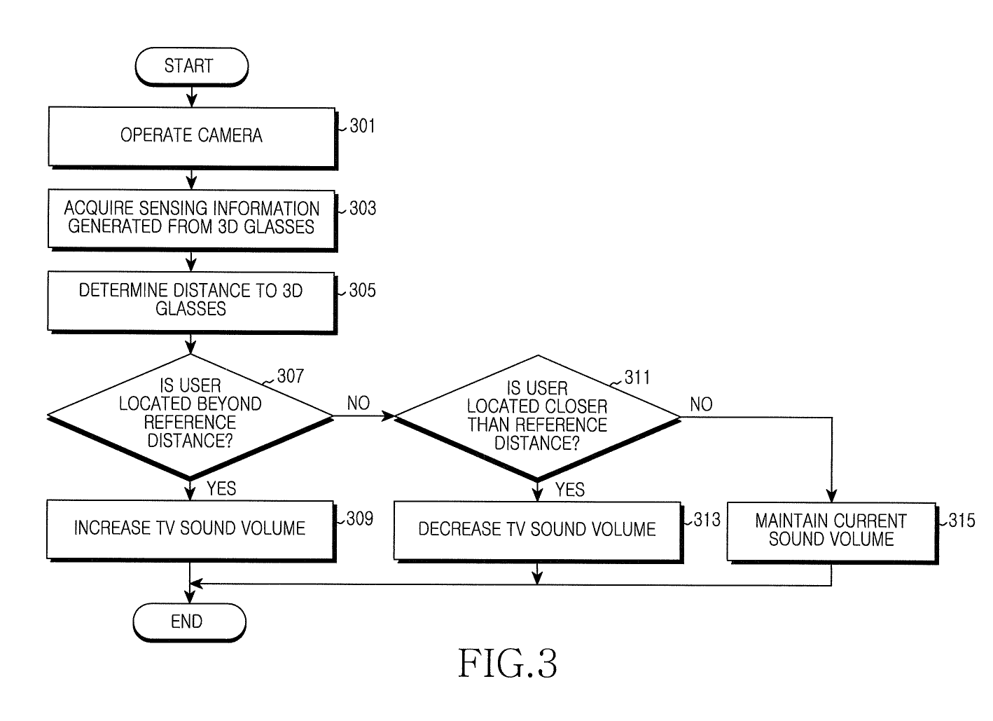

FIG. 3 illustrates a process of regulating a sound volume depending on a location of a user in a video device according to an embodiment of the present disclosure.

Referring to FIG. 3, the video device drives a camera provided to recognize a posture of the user who wears 3D glasses in step 301. In step 303, the video device acquires sensing information generated from the 3D glasses worn by the user who desires to watch a 3D video. In step 305, the video device determines a distance to the 3D glasses, that is, a distance to the user who wears the 3D glasses. According to an embodiment, the video device may use the strength of the sensing information generated from the 3D glasses to determine the distance to the user.

In step 307, the video device determines whether the user is located beyond a reference distance from the video device. That is whether the user is located far than the reference distance from the video device.

Herein, the reference distance is defined as a distance within which from the video device the user can feel a sound output from the video device as an optimal sound.

If it is determined in step 307 that the user is located beyond the reference distance (i.e., the user is located far from the video device), the video device can determine that the user may feel that the output sound is not loud enough. Therefore, proceeding to step 309, the video device increases a currently configured sound volume (e.g. according to the determined distance) such that the user can feel an optimal sound.

Otherwise, if it is determined in step 307 that the user is not located beyond the reference distance, proceeding to step 311, the video device determines whether the user is located closer than or equal to the reference distance.

If it is determined in step 311 that the user is located within the reference distance (i.e., a distance close to the video device), the video device can determine that the user may feel that the output sound is too loud. Therefore, proceeding to step 313, the video device decreases the currently configured sound volume (e.g. according to the determined distance) such that the user can feel the optimal sound.

If it is determine in step 311 that the user is not located within the reference distance, the video device can determine that the user is located in a position capable of feeling the optimal sound. Therefore, proceeding to step 315, the video device maintains the currently configured sound volume, and then the process of FIG. 3 ends.

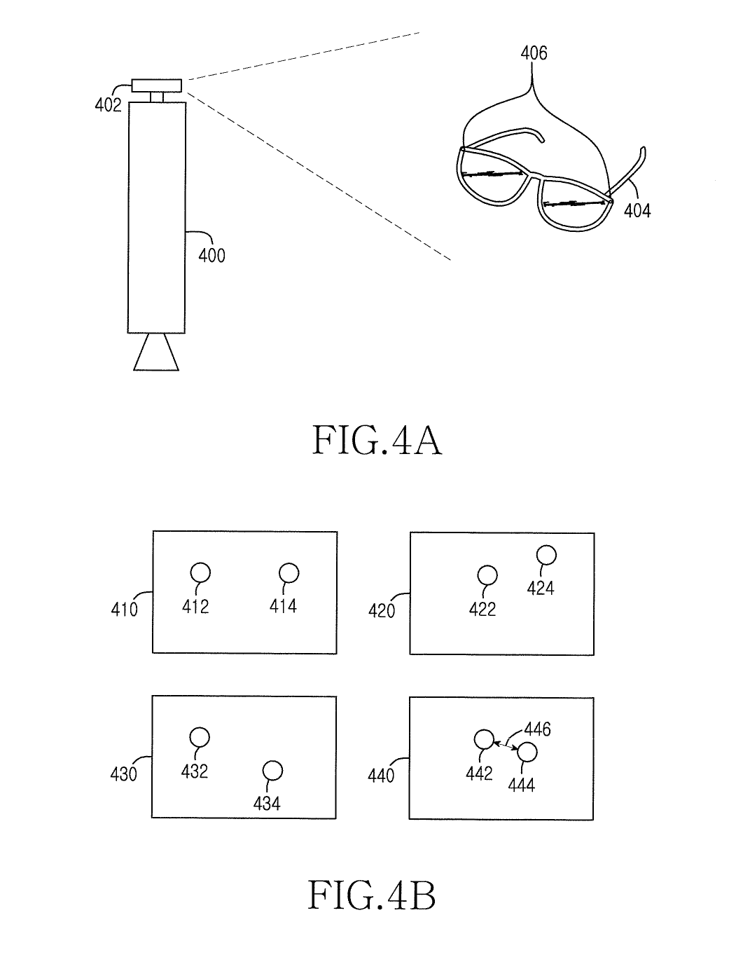

FIGS. 4A and 4B illustrate recognizing a posture of a user in a video device according to an embodiment of the present disclosure.

FIG. 4A illustrates acquiring sensing information generated from 3D glasses in a video device according to an embodiment of the present disclosure.

Referring to FIG. 4A, a video device 400 may be a 3D TV set that outputs 3D video. The video device 400 includes a camera 402 (or a sensor) for acquiring sensing information generated from the 3D glasses worn by the user.

3D glasses 404 include a plurality of sensors (or sensing information generator) (not shown) for providing sensing information 406 that can be acquired by the camera 402, and thus can generate the sensing information while watching the 3D video.

Therefore, the video device 400 acquires the sensing information by using the camera 402 (or a sensor). Horizontal information and vertical information of the 3D glasses can be recognized by using the acquired sensing information.

FIG. 4B illustrates a screen for acquiring sensing information generated from 3D glasses in a video device according to an embodiment of the present disclosure.

Referring to FIG. 48, the video device can acquire sensing information generated from the 3D glasses by using a camera.

As illustrated in FIG. 4B, data captured by the camera is indicated by a rectangular box, and a location of the sensing information generated from the 3D glasses is indicated by a circle depicted inside the box.

If it is determined that two pieces of sensing information 412 and 414 are horizontally aligned to each other as indicated by a reference numeral 410, the video device can determine a state of the 3D glasses that maintains a posture in which the user who wears the 3D glasses can acquire an optimal 3D effect, that is, a state in which the 3D glasses are horizontally aligned to a screen for outputting a stereoscopic video.

If it is determined that two pieces of sensing information 422 and 424 are not horizontally aligned as indicated by a reference numeral 420, the video device can determine that a current posture is not a posture in which the user who wears the 3D glasses can acquire the optimal 3D effect. The reference numeral 420 indicates a state in which the user is watching the 3D video while leaning to the left (e.g. the user's head is tilted to the left).

If it is determined that two pieces of sensing information 432 and 434 are not horizontally aligned to each other as indicated by a reference numeral 430, the video device can determine that the current posture is not a posture in which the user who wears the 3D glasses can acquire the optimal 3D effect. The reference numeral 430 indicates a state in which the user is watching the 3D video while leaning to the right (e.g. the user's head is tilted to the right).

The aforementioned reference numerals 410 to 430 indicate a state in which the user watches a stereoscopic video in an incorrect angle from the center of the video device. Therefore, the video device allows one side (i.e., any one of left and right directions) of a screen for outputting the stereoscopic video to be regulated upwards and downwards (i.e., angle regulation), thereby providing the optimal 3D effect.

If it is determined that two pieces of sensing information 442 and 444 are not horizontally aligned to each other and a distance between the two pieces of information is decreasing, the video device can determine that the user who wears the 3D glasses watches the 3D video while leaning to the left or right from the center of the video device. The aforementioned situation can be determined by using the distance between the two pieces of sensing information even in a state where the two pieces of sensing information are horizontally aligned to each other. At the occurrence of such a situation, the video device allows the screen for outputting the stereoscopic video to be regulated in a clockwise direction or a counter-clockwise direction (i.e., direction regulation), thereby providing the optimal 3D effect.

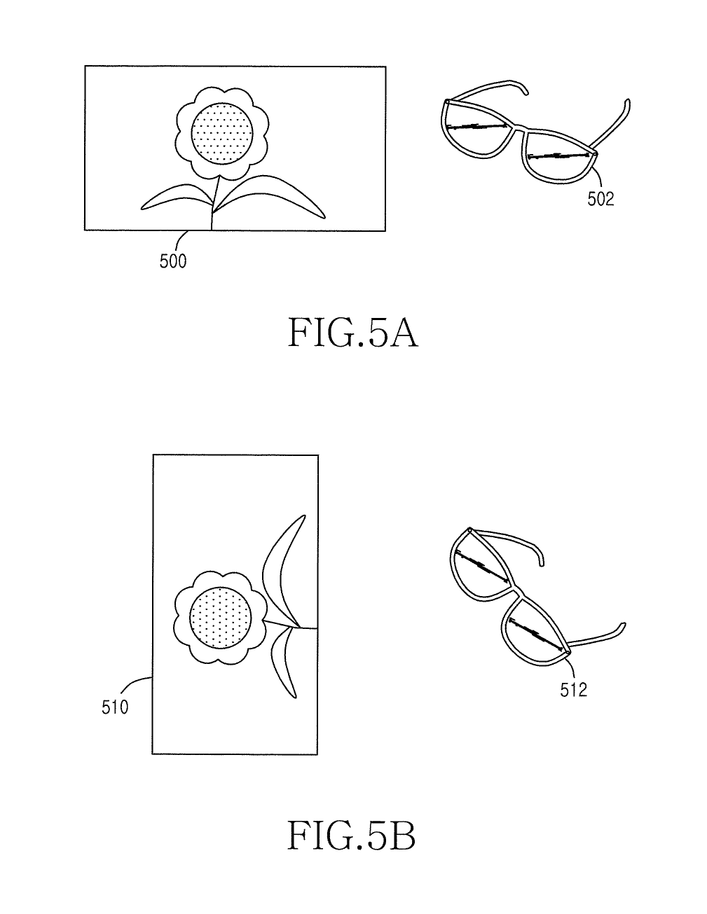

FIGS. 5A and 5B illustrate changing an output screen depending on a posture of 3D glasses in a video device according to an embodiment of the present disclosure.

FIG. 5A illustrates a situation capable of providing an optimal stereoscopic effect in a video device according to an embodiment of the present disclosure.

Referring to FIG. 5A, a video device 500 is horizontally aligned to 3D glasses 502 worn by a user. Therefore, the user can acquire an optimal 3D effect.

FIG. 5B illustrates changing a screen configuration depending on a posture of a user in a video device according to an embodiment of the present disclosure.

Referring to FIG. 5B, when a video device 510 is not horizontally aligned to 3D glasses 512 worn by the user, the video device 510 cannot provide an optimal 3D effect to the user.

That is, when the user lies down to watch a 3D video of the video device 510 located in a regular position as illustrated in FIG. 5A, the user cannot feel the optimal 3D effect. Thus, the video device 510 is adjusted to be horizontally aligned to the 3D glasses 512 according to the present disclosure.

For example, when the user who wears the 3D glasses 512 lies to the left to watch a stereoscopic video, the video device 510 rotates a screen for outputting the stereoscopic video by 90 degrees so as to be horizontally allied to the 3D glasses 512 of the user.

As described above, the present disclosure relates to a video device for providing an optimal 3D effect to a user. By regulating a sound volume and an angle of an output screen depending on a location of the user who wears 3D glasses, it is possible to solve the conventional problem in which the optimal effect can be provided only when the user has a correct posture.

While the present disclosure has been particularly shown and described with reference to embodiments thereof, it will be understood by those skilled in the art that various changes in form and details may be made therein without departing from the spirit and scope of the present disclosure as defined by the appended claims.

What is claimed is:

1. An apparatus for providing a stereoscopic effect, the apparatus comprising:
a 3 Dimensional (3D) glasses recognition unit configured to determine a posture of a user who watches a stereoscopic video; and
a controller configured to provide control to change the stereoscopic effect of the stereoscopic video according to the posture of the user determined by the 3D glasses recognition unit.

2. The apparatus of claim 1, wherein the 3D glasses recognition unit is further configured to operate a camera to acquire sensing information from 3D glasses worn by the user, and determine the posture of the user by using the acquired sensing information.

3. The apparatus of claim 2, wherein the 3D glasses include a plurality of light emitting sensing information generators to generate the sensing information.

4. The apparatus of claim 1, wherein the controller is further configured to change at least one of an output screen direction of the video device depending on the determined posture of the user and an output sound volume of the video device in order to change the stereoscopic effect.

5. The apparatus of claim 4, wherein the controller is further configured to regulate at least one of an angle and direction against the output screen when it is determined that the posture of the user is a posture capable of feeling an optimal stereoscopic effect.

6. The apparatus of claim 4, wherein the controller is further configured to provide the stereoscopic effect by horizontally aligning the 3D glasses worn by the user to the output screen.

7. The apparatus of claim 4, wherein the controller is further configured to determine a distance between the user and the video device and regulate the sound volume depending on the determined distance so as to change a volume of the output sound.

8. A method of providing a stereoscopic effect, the method comprising:
determining, by a 3 Dimensional (3D) glasses recognition unit, a posture of a user who watches a stereoscopic video; and
changing the stereoscopic effect of the stereoscopic video depending on the determined posture of the user.

9. The method of claim 8, wherein determining the posture of the user who watches the stereoscopic video comprises:
operating at least one of a camera and a sensor capable of acquiring the posture of the user;
acquiring sensing information from 3D glasses worn by the user; and
determining the posture of the user by using the acquired sensing information.

10. The method of claim 9, wherein the 3D glasses include a plurality of light emitting sensing information generators to generate the sensing information.

11. The method of claim 8, wherein changing the stereoscopic effect of the stereoscopic video depending on the determined posture of the user comprises at least one of:
changing an output screen direction; and
changing an output sound volume.

12. The method of claim 11, wherein changing the output screen direction comprises:
determining whether the posture of the user is a posture capable of feeling an optimal stereoscopic effect; and
when the posture of the user is the posture capable of feeling an optimal stereoscopic effect, regulating at least one of an angle and a direction against the output screen.

13. The method of claim 11, wherein changing the output screen direction comprises changing the direction of the output screen such that the 3D glasses worn by the user are horizontally aligned to the output screen.

14. The method of claim 11, wherein changing the output sound volume comprises:
determining a distance between the user and the video device; and
regulating the sound volume depending on the determined distance.

15. An apparatus, comprising:
a three-dimensional (3D) viewing device recognition unit configured to determine a posture of a user who watches a stereoscopic video; and
a controller configured to adjust a stereoscopic effect of a display device according to the determined posture of the user.

16. The apparatus of claim 15, wherein the 3D viewing device recognition unit is further configured to operate one of a camera and a sensor to acquire sensing information from a 3D viewing device worn by the user.

17. The apparatus of claim 16, wherein the 3D viewing device includes a plurality of light emitting devices configured to be detected by the one of the camera and the sensor to acquire the sensing information.

18. The apparatus of claim 15, wherein the controller is further configured to change at least one of an orientation of the display device according to the determined posture of the user and an output sound volume in order to change the stereoscopic effect.

19. The apparatus of claim 18, wherein the controller is further configured to determine whether the determined posture of the user is a posture capable of feeling an optimal stereoscopic effect, and regulate at least one of an angle and direction of the display device when the determined posture of the user is not a posture capable of feeling the optimal stereoscopic effect.

20. The apparatus of claim 18, wherein the controller is further configured to determine whether the determine whether the determined posture of the user is a posture capable of feeling the optimal stereoscopic effect based on whether the sensing information indicates that the display device and the 3D viewing device are horizontally aligned.
